(19) United States
(12) Patent Application Publication
(10) Pub. No.: US 2014/0376401 A1
(43) Pub. Date: Dec. 25, 2014

(54) AVERAGING BUFFER OCCUPANCY TO IMPROVE PERFORMANCE AT A USER EQUIPMENT (UE)

(71) Applicant: QUALCOMM Incorporated, San Diego, CA (US)

(72) Inventors: Sitaramanjaneyulu Kanamarlapudi, San Diego, CA (US); Liangchi Hsu, San Diego, CA (US); Rohit Kapoor, San Diego, CA (US); Venkata Ramanan Venkatachalam Jayaraman, Del Mar, CA (US); Rashid Ahmed Abkar Attar, San Diego, CA (US); Harish Venkatachari, Sunnyvale, CA (US)

(21) Appl. No.: 14/306,949

(22) Filed: Jun. 17, 2014

Related U.S. Application Data
(60) Provisional application No. 61/837,725, filed on Jun. 21, 2013.

(51) Int. Cl. H04W 24/02; H04W 72/04; H04W 24/08

(52) U.S. Cl. CPC H04W 24/02; H04W 24/08; H04W 72/048; H04W 72/042; H04W 72/0473
USPC 370/253

(57) ABSTRACT

The present disclosure presents a method and an apparatus for improving performance at a user equipment (UE). For example, the method may include calculating an average buffer occupancy value at the UE, sending a request for resources from the UE to a base station in communication with the UE, wherein request for the resources is based on the average buffer value, receiving resources from the base station based on the request sent from the UE, and transmitting data on a uplink (UL), from the UE to the base station, based on one or more of data available for transmission at the UE, or an available transmit power at the UE, or the resources received from the base station. As such, improved performance at a UE is achieved.

### CLAIM OF PRIORITY

The present application for patent claims priority to U.S. Provisional Patent Application No. 61/837,725, filed Jun. 21, 2013, entitled “Method and Apparatus for Aggregating Data to Improve Signaling and Power Performance,” which is assigned to the assignee hereof, and hereby expressly incorporated by reference herein.

### BACKGROUND

Aspects of the present disclosure relate generally to wireless communication systems, and more particularly, to aggregating data for improving performance at a user equipment (UE).

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In a wireless network, radio link control (RLC) layer at a user equipment (UE) tries to transmit maximum amount of data (e.g., maximum number of bits) on a uplink (UL) from the UE to a base station which is generally limited by a grant from the base station or amount of data in a buffer at the UE (e.g., buffer occupancy). The amount of data transmitted on the UL from the UE may vary considerably when the grants to the UE and/or the buffer occupancy at the UE are dynamic. This may result in the UE operating in different power amplifier (PA) states causing sudden transitions and associated high power usage. For example, if the UE transitions between a high PA state (PA2) and a low PA state (PA0), or vice versa, that have different power requirements, the amount of power (e.g., battery power at the UE) consumed will be relatively higher, especially for smaller amounts of bursty traffic that is transmitted periodically.

Therefore, there is a desire for a method and an apparatus for averaging buffer occupancy to improve performance at a user equipment.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents an example method and apparatus for improving performance at a user equipment (UE). For example, the present disclosure presents an example method for calculating an average buffer occupancy value at the UE, sending a request for resources from the UE to a base station in communication with the UE, wherein request for the resources is based on the average buffer value, receiving resources from the base station based on the request sent from the UE, and transmitting data on a uplink (UL), from the UE to the base station, based on one or more of data available for transmission at the UE, or an available transmit power at the UE, or the resources received from the base station.

Additionally, the present disclosure presents an example apparatus for improving performance at a UE that may include means for calculating an average buffer occupancy value at the UE, means for sending a request for resources from the UE to a base station in communication with the UE, wherein request for the resources is based on the average buffer value, means for receiving resources from the base station based on the request sent from the UE, and means for transmitting data on a uplink (UL), from the UE to the base station, based on one or more of data available for transmission at the UE, or an available transmit power at the UE, or the resources received from the base station.

In a further aspect, the presents disclosure presents an example non-transitory computer readable medium for improving performance at a UE comprising code that, when executed by a processor or processing system included within the UE, causes the UE to calculate an average buffer occupancy value at the UE, send a request for resources from the UE to a base station in communication with the UE, wherein request for the resources is based on the average buffer value, receive resources from the base station based on the request sent from the UE, and transmitting data on a uplink (UL), from the UE to the base station, based on one or more of data available for transmission at the UE, or an available transmit power at the UE, or the resources received from the base station.

Furthermore, in an aspect, the present disclosure presents an example apparatus for improving performance at a UE that may include an average buffer occupancy value calculating component to calculate an average buffer occupancy value at the UE, a resource request sending component to send a request for resources from the UE to a base station in communication with the UE, wherein request for the resources is based on the average buffer value, a resource receiving component to receive resources from the base station based on the request sent from the UE, and a data transmitting component to transmit data on a uplink (UL), from the UE to the base station, based on one or more of data available for transmission at the UE, or an available transmit power at the UE, or the resources received from the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system in aspects of the present disclosure;

FIG. 2 is a flow diagram illustrating aspects of an example method in aspects of the present disclosure;

FIG. 3 is a block diagram illustrating an example performance manager in aspects of the present disclosure;

FIG. 4 is a block diagram illustrating aspects of a computer device according to the present disclosure;

FIG. 5 is a block diagram conceptually illustrating an example of a telecommunications system;

FIG. 6 is a conceptual diagram illustrating an example of an access network;

FIG. 7 is a conceptual diagram illustrating an example of a radio protocol architecture for the user and control plane; and

FIG. 8 is a block diagram conceptually illustrating an example of a NodeB in communication with a UE in a telecommunications system. FIG. 1 is a block diagram illustrating an example wireless system of aspects of the present disclosure;

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure provides a method and apparatus for improving performance at a user equipment (UE). For example, the method may include sending a request for resources to a base station based on an average buffer occupancy value and transmitting data on a UL from the UE to the base station based on resources received from the base station, data available for transmission at the base station, and/or transmit power available at the base station.

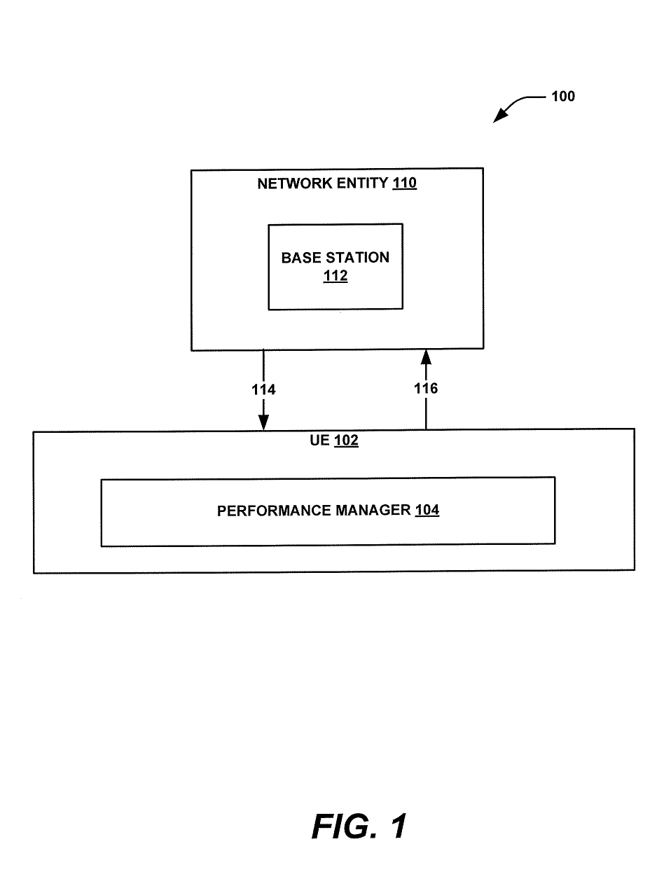

Referring to FIG. 1, a wireless communication system 100 is illustrated that facilitates improving performance at a user equipment (UE). For example, system 100 includes a UE 102 that may communicate with a network entity 110 via one or more over-the-air links 114 and/or 116. In an aspect, for example, network entity 110 may include a base station 112 that communicates with UE 102 on a downlink 114 and/or a uplink 116. A downlink (DL) is generally used for communication from the base station to the UE and the uplink (UL) is generally used for communication from the UE to the base station.

In an aspect, base station 112 may be configured with one or more cells for supporting communications with UE 102 and other UEs. In an additional aspect, a cell associated with base station 112 may be a serving cell of UE 102 (e.g., UE 102 is camped on a cell associated with base station 112).

In an aspect, network entity 110 may include one or more of any type of network components, for example, an access point, including a base station (BS) or Node B or eNodeB or a femto cell, a relay, a peer-to-peer device, an authentication, authorization and accounting (AAA) server, a mobile switching center (MSC), a radio network controller (RNC), etc., that can enable UE 102 to communicate and/or establish and maintain links 114 and/or 116 to communicate with network entity 110 and/or base station 112. In an additional aspect, for example, network entity 110 may operate according to a radio access technology (RAT) standard, e.g., GSM, CDMA, W-CDMA, HSPA or a LTE.

In an additional aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

For example, when UE 102 has data to transfer on the UL (e.g., user of UE 102 has data to transfer on the UL), UE 102 sends a request for resources (e.g., grant, transmit (tx) power, etc.) to base station 112. When UE 102 receives resources from base station 112, UE 102 tries to send a maximum amount of data that can be transmitted on the UL from the UE which is generally limited or restricted on resources received from the base station.

For example, a UE may request resources to transmit data on a UL from the UE to a base station in small bursts. This may require a modem in to wake up from sleep (e.g., when the modem is in a sleep state) and go through several state transitions to transmit the data and this process may repeat periodically (e.g., may repeat every 300 ms) as the data is transmitted in small bursts. But, the state transitions needed prior to transmitting the data on the UL may result in unnecessary signaling and/or power consumption overhead at the UE with no significant improvement in the UE performance. Further, a UE may be moving to a dedicated channel (DCH) or a high speed packet access (HSPA) channel based on network configuration to transmit the data on the uplink to a base station. Furthermore, when the UE reports high speed (HS) and/or enhanced uplink (EUL) capability, a network entity and/or a base station may keep the UE in HSPA mode for better performance (e.g., higher throughput on the UL).

Additionally, the UE may frequently move between DCH and forward access channel (FACH) mode of operation or high speed-random access channel (HS-RACH) collision resolution phase to inactive grant based on total enhanced dedicated channel (E-DCH) buffer status condition (for example, total E-DCH Buffer Status (TEBS)=0). Although, this may facilitate the transmitting data on the UL at a higher rate, the improvement in performance (e.g., throughput) at the UE decreases especially when the amount of data transmitted from the UE to the base station is small (e.g., periodic, small bursts of data).

In a further example, additional overhead includes configuration of various hardware blocks and enabling of receivers at the UE. The hardware blocks may be related to, e.g., high speed downlink packet access (HSDPA) specific blocks for decoding high speed-shared control channel (HS-SCCH) and physical downlink shared channel (PDSCH), EUL specific blocks for encoding the transport block size (TBS), and data movers (direct memory access) and associated bus bandwidth. Further, operations include hybrid automatic repeat request (HARQ) level buffer management in DL as well as UL and associated memory usage, and the transmitting on the UL may also required higher clock speeds at system level to support HSDPA/EUL which may have higher power requirements.

For example, configuration of the HSDPA/EUL channels at the UE may take some time in terms of the channel configuration procedures as well as software/firmware interactions to ensure correct channel configuration. The de-configuration of HSDPA/EUL channels may also take some time in terms of tearing down the channels and transitioning to FACH/Idle states. For example, in an aspect, if UE 102 has 300 bytes of data for transmitting on the UL from UE 102 to base station 112, base station 112 may allocate HSPA channels for transmitting the data on the UL from UE 102 to base station 112. In an additional aspect, UE 102 and/or performance manager 104 may take into consideration the number of blocks and/or number of TTIs required for transmitting the data on the UL from the UE to the base station, configuration overhead described above in terms of reconfiguration procedures as well as system level hardware, software, and firmware blocks along with higher clock requirements, which may not be efficient.

In an aspect, UE 102 may include a performance manager 104 for improving performance of UE 102 by calculating an average buffer occupancy value at the UE, sending a request for resources from the UE to a base station in communication with the UE, wherein request for the resources is based on the average buffer value, receiving resources from the base station based on the request sent from the UE, and transmitting data on a uplink (UL), from the UE to the base station, based on one or more of data available for transmission at the UE, or an available transmit power at the UE, or the resources received from the base station.

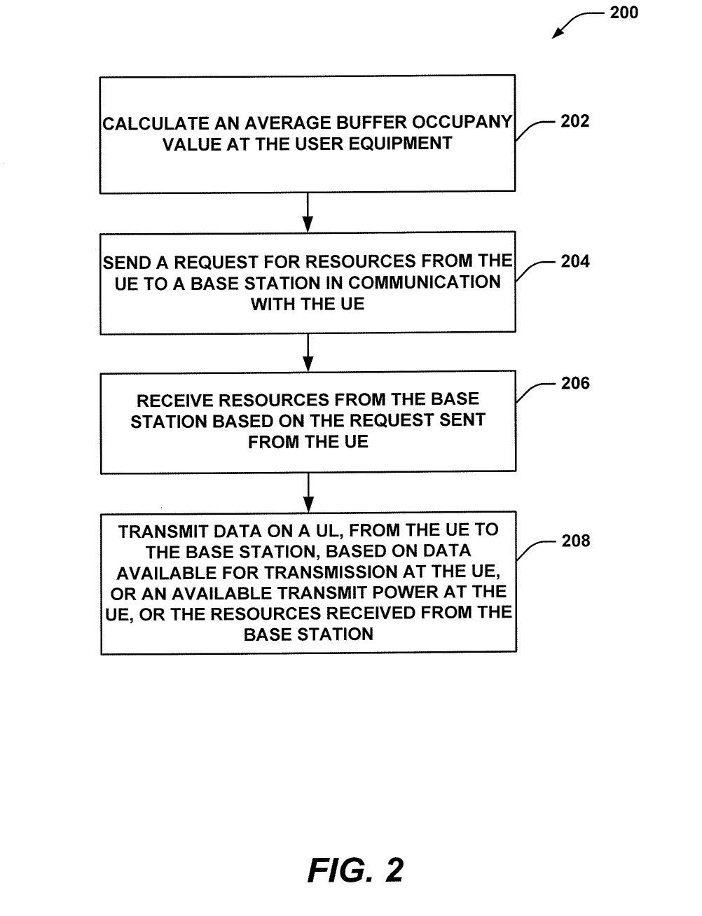

FIG. 2 illustrates an example methodology 200 for improving performance at a user equipment.

In an aspect, at block 202, methodology 200 may include calculating an average buffer occupancy value at the UE. For example, in an aspect, UE 102 and/or performance manager 104 may include a specially programmed processor module, or a processor executing specially programmed code stored in a memory, to calculate an average buffer occupancy value at UE 102.

In an aspect, when UE 102 and/or performance manager 104 receives a request to transmit data on the UL (e.g., on UL 116) from UE 102 to base station 112, UE 102 and/or performance manager 104 may store (e.g., save) the data at the UE (e.g., in a buffer at UE 102) and may calculate the average buffer occupancy value at the UE. In an additional or optional aspect, UE 102 and/or performance manager 104 may calculate the average buffer occupancy value based over a number of frames or a period of time, and/or a combination of both.

For example, UE 102 and/or performance manager may calculate the average buffer occupancy value over a “X” number of frames (e.g., 20 frames). That is, the average buffer occupancy value may be calculated over 20 frames, and each frame may be a 2 ms or a 10 ms transmission time interval (TTI). The TTI is related to the size of the data blocks passed from higher network layers to a radio link layer. In an additional or optional aspect, UE 102 and/or performance manager may calculate the average buffer occupancy value over a “Y” period of time (e.g., over a period of 50 ms). In an optional aspect, UE 102 and/or performance manager may calculate the average buffer occupancy value over a combination of “X” number of frames and a “Y” period of time (e.g., the average buffer occupancy value is calculated over at least 40 frames and at least over 50 ms).

In an aspect, the request to transmit data from UE 102 to base station 112 may be from an application running on UE 102 and the application may be an application that is running in the foreground (e.g., a new application launched by a user of the UE or an application a user on the UE is currently interacting with) or an application running in the background (e.g. an application that may be always running but it's not the application the user on the UE is currently interacting with).

In an optional aspect, the size of the buffer may be configurable at the UE, and the performance manager 104 may calculate average buffer values on a continuous basis. In a further optional aspect, the values of “X” and/or “Y” may be configurable based on the performance requirements of the UE and/or the network entity.

In an aspect, at block 204, methodology 200 may include sending a request for resources (e.g., UL resources—grants, transmit (tx) power, codes, etc.) from the UE to a base station in communication with the UE. For example, in an aspect, UE 102 and/or performance manager 104 may include a specially programmed processor module, or a processor executing specially programmed code stored in a memory, to send a request for resources from UE 102 to base station 112. The request sent from UE 102 to base station 112 may request resources (e.g., grants, tx power, codes, etc.) for transmitting the data stored in the buffer from the UE to the base station.

In an additional aspect, the request sent from UE 102 to base station 112 may include the calculated average buffer occupancy values. For example, in an aspect, the request sent from UE 102 may include the calculated average buffer occupancy values so that the base station is aware of the amount of the resources being requested by the UE. In an additional or optional aspect, UE 102 and/or performance 104 may send a request to base station that include an average buffer occupancy value that is lower than the calculated average buffer occupancy value. This may result in base station 112 considering the lower average buffer occupancy value when assigning resources to UE 102 and may result in a smaller amount (e.g., less) of resources being assigned to UE 102 by base station 112. In an additional aspect, the request from UE 102 to base station 112 may be sent via scheduling information (SI) to base station 112.

In an aspect, at block 206, methodology 200 may include receiving resources from the base station based on the request sent from the UE. For example, in an aspect, UE 102 and/or reselection manager 104 may include a specially programmed processor module, or a processor executing specially programmed code stored in a memory, to receive resources from the base station based on the request sent from the UE.

In an aspect, UE 102 and/or performance manager 104 may receive resources (e.g. grants, codes, tx power, etc.) from base station 112. The resources received from base station 112 may be assigned by base station 112 to UE 102 based on the average buffer occupancy values reported by UE 102 in the request sent from the UE. In additional or optional aspect, the resources received by the UE may be lower than the resources needed for transmitting the data (e.g., data stored in the buffer) on the UL from UE 102 as UE 102 and/or performance manager 104 may have reported an average buffer occupancy that is lower than the calculated average buffer occupancy value.

In an aspect, at block 208, methodology 200 may include transmitting data on a uplink (UL) from the UE to the base station. For example, in an aspect, UE 102 and/or performance manager 104 may include a specially programmed processor module, or a processor executing specially programmed code stored in a memory to transmit data on a UL (e.g., 116) from UE 102 to base station 112. In an additional aspect, the data transmitted on the UL from UE 102 to base station 112 may be based on one or more of data available for transmission at UE 102, or an available transmit power at UE 102, or resources received from base station 112.

In an additional aspect, UE 102 and/or performance manager 104 may distribute the data available for transmitting on the UL over a number of frames. For example, UE 102 and/or performance manager 104 may transmit the data on the UL over an increased number of frames, but may reduce the number of PA state transitions and total power requirements at UE 102.

In an aspect, for example, UE 102 and/or base station 112 may take into consideration data available for transmission at UE 102 (e.g., in the buffer at UE 102), transmit power available at UE 102, and/or resources received from base station 112 prior to transmitting the data from UE 102 to base station 112.

For example, UE 102 may have 10,000 bytes of data for transmission on the UL to base station 112. The UE may have received resources (e.g., grant) from base station 112 to transmit 8,000 bytes of data (e.g., 8,000 bytes of data in a TTI) with UE 102 having tx power to transmit 10,000 bytes. In this example, the UE may transmit 8,000 bytes (e.g., limited by the received grant) in a first TTI and may transmit the remaining 2,000 bytes in a second TTI. However, for the UE to transmit 8,000 bytes of data in the first TTI, the UE has to transition to a high PA state (e.g., PA2 state) and then transition to a low PA state (e.g., PA0 state) to transmit the remaining 2,000 bytes in the second TTI. Additionally, the transition from high PA state to low PA state (and vice versa) and/or the transitioning occurring quickly (e.g., successive TTIs) may result in non-linear performance (e.g., exponential) at the UE, which is not efficient.

Therefore, in an aspect, UE 102 and/or performance manager 104 may distribute the data available for transmission over a higher number of frames (e.g., 5 frames) with UE 102 in a low PA state (e.g., PA0 state). This allows UE 102 to transmit the available data (e.g., 10,000 byte) from UE 102 to base station 112 with the UE in a low PA state while saving power at the UE as the UE uses less power when the UE is transmitting in a low PA state. Further, the UE may also achieve additional power savings as the UE may not have to transition from a high PA state to a low PA state as the UE stays in the low PA state during the transmission of the data (e.g., 10,000 bytes). Furthermore, the UE may not have to perform sudden transitions (e.g., transition from a high PA state to a low PA state during successive TTIs) as the UE may remain in one PA state during the transmission of the data on the UL from the UE to the base station.

In an additional or optional aspect, network entity 110 and/or the base station 112 may only allocate a portion of the resources that were requested by the UE as the resources are generally shared with other UEs communicating with the network entity 110 and/or base station 112. In such a scenario, UE 102 may transmit the data on the UL to base station 112 to the extent permitted based on the resource allocation to the UE while minimizing PA state transitions as described above, and the UE may continue buffering data, calculating average buffer occupancy values, and requesting resources on a continuous basis until resources are assigned to the UE for transmitting the data available for transmission at the UE. This may allow timely (e.g., efficient) transmission of the data on the UL from UE 102 to base station 112 instead of waiting for all of the requested resources to be granted at once prior to the transmitting of the data on the UL from the UE to the base station.

In an additional or optional aspect, prior to aggregating data, UE 102 and/or performance manager 104 may identify whether data for transmitting on the UL from the UE to the base station is delay sensitive. For example, the identifying may be based on whether data to be transmitted is associated with a priority message (e.g., signaling message), a priority application (e.g., E911 call), a voice call, and/or an application with a specific quality of service (QoS) requirement. For example, once UE 102 and/or performance manager 104 identifies that the data for transmitting on the UL is delay sensitive, as described above, UE 102 and/or performance manager 104 may transmit the data immediately without delay (e.g., delay associated with transmitting data based on resources received on average buffer occupancy values) from the UE 102 to base station 112.

In an additional or optional aspect, UE may calculate average buffer occupancy values for improving performance at the UE related to minimizing of PA state transitions described above. For example, there may be default grant (common resources) available to UE on HS_RACH or TFC configured in R99 channels, and the UE may not need any further commands from network entity 110 and/or base station 112. The UE may calculate average buffer occupancy values to minimizing PA state transitions to achieve improved performance at the UE performance (e.g., in terms of power, battery etc.).

In an additional aspect, when UE 102 has large amount of data which may span across multiple TTIs on the U (e.g., a large file transfer or a video upload), it may be efficient to transmit the data with the UE in higher PA state as the increase in throughput will be higher than the configuration/re-configuration overhead as described above.

Thus, as described above, improved performance at a UE by averaging buffer occupancy may be achieved.

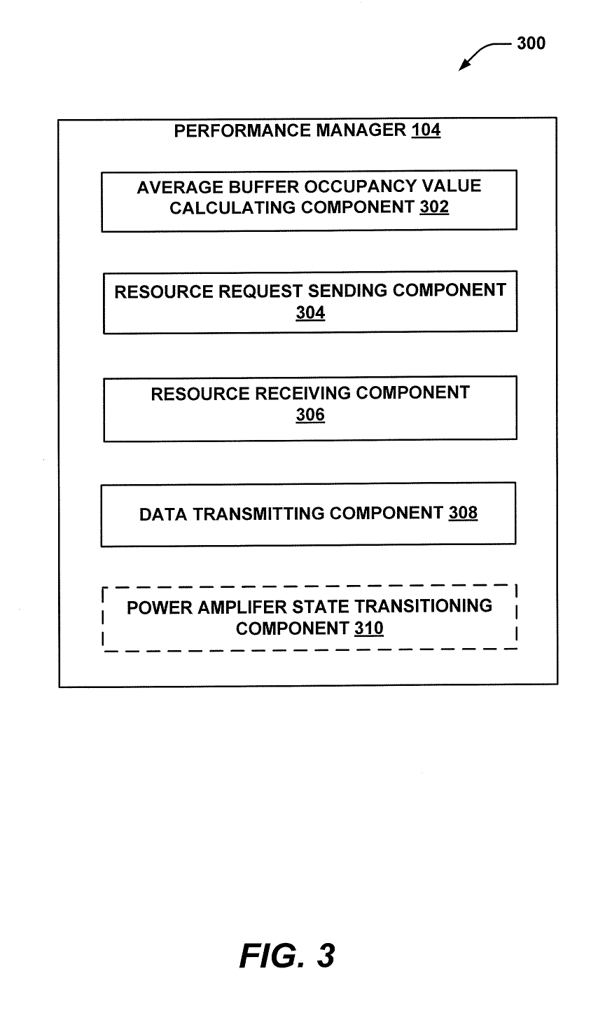

Referring to FIG. 3, illustrated is an example performance manager 104 and various sub-components for improving performance at a UE. In an example aspect, performance manager 104 may be configured to include the specially programmed processor module, or the processor executing specially programmed code stored in a memory, in the form of an average buffer occupancy value calculating component 302, resource request sending component 304, resource receiving component 306, and/or a data transmitting component 308, such as in specially programmed computer readable instructions or code, firmware, hardware, or some combination thereof. In an optional aspect, performance manager 104 may be configured to include a power amplifier (PA) state transitioning component 310. In an aspect, a component may be one of the parts that make up a system, may be hardware or software, and may be divided into other components.

In an aspect, performance manager 104 and/or average buffer occupancy value calculating component 302 may be configured to calculate an average buffer occupancy value at the UE. For example, in an aspect, average buffer occupancy value calculating component 302 may be configured to calculate average buffer occupancy values of UE 102. In an additional aspect, average buffer occupancy value calculating component 302 may be configured to calculate the average buffer occupancy values based at least over a number of frames, period of time, and/or a combination of the both as described above.

In an aspect, performance manager 104 and/or resource request sending component 304 may be configured to send a request for resources from the UE to a base station in communication with the UE. For example, in an aspect, resource request sending component 304 may be configured to send a request for resources from UE 102 to base station 112 that is in communication with UE 102. In an additional aspect, base station 112 may be a serving cell of UE 102 (e.g., UE 102 is camped on a cell associated with base station 112). In a further additional aspect, resource request sending component 304 may be configured to send the request to the base station wherein the request is based on the calculated average buffer occupancy value.

In an aspect, performance manager 104 and/or resource receiving component 306 may be configured to receive resources from the base station. For example, in an aspect, resource receiving component 306 may be configured to may be configured to receive resources from base station 112. In an additional aspect, the resources received from base station 112 may be based on the request sent from the UE where the request includes an average buffer occupancy value at UE 102.

In an aspect, performance manager 104 and/or data transmitting component 308 may be configured to transmit data on a UL from the UE to the base station. For example, in an aspect, data transmitting component 308 may be configured to transmit data from UE 102 to base station 112. In an additional aspect, the data transmitted from the UE to the base station may be based on one or more of data available for transmission at UE 102 (e.g. data in the buffer), or an available transmit power at UE 102, or resources received (e.g., grant) received from based station 112.

In an optional aspect, performance manager 104 and/or power amplifier (PA) state transitioning component 312 may be configured to distribute data for transmission over a number of frames. For example, in an aspect, power amplifier (PA) state transitioning component 312 may be configured to transmit data from UE 102 to base station 112 over a number of frames. In an additional aspect, power amplifier (PA) state transitioning component 312 may be configured to transmit the data from UE 102 to base station 112 with the UE in a low PA state and/or minimizing the transitions between the PA states for improving performance at the UE.

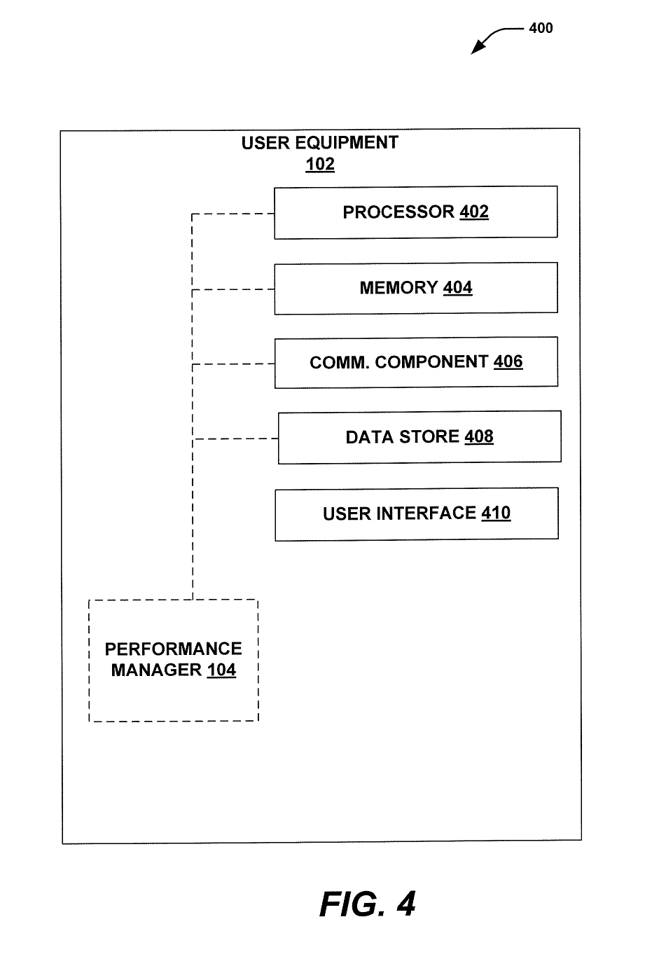

Referring to FIG. 4, in an aspect, UE 102, for example, including performance manager 104, may be or may include a specially programmed or configured computer device. In one aspect of implementation, UE 102 may include performance manager 104 and its sub-components, including average buffer occupancy value calculating component 302, resource request sending component 304, resource receiving component 306, and/or data transmitting component 308, such as in specially programmed computer readable instructions or code, firmware, hardware, or some combination thereof.

In an aspect, for example as represented by the dashed lines, performance manager 104 may be implemented or executed using one or any combination of processor 402, memory 404, communications component 406, and data store 408. For example, performance manager 104 may be defined or otherwise programmed as one or more processor modules of processor 402. Further, for example, performance 104 may be defined as a computer-readable medium stored in memory 404 and/or data store 408 and executed by processor 402. Moreover, for example, inputs and outputs relating to operations of performance manager 104 may be provided or supported by communications component 406, which may provide a bus between the components of computer device 400 or an interface to communication with external devices or components.

UE 102 may include a processor 402 specially configured to carry out processing functions associated with one or more of components and functions described herein. Processor 402 can include a single or multiple set of processors or multi-core processors. Moreover, processor 402 can be implemented as an integrated processing system and/or a distributed processing system.

User equipment 102 further includes a memory 404, such as for storing data used herein and/or local versions of applications and/or instructions or code being executed by processor 402, such as to perform the respective functions of the respective entities described herein. Memory 404 can include any type of memory usable by a computer, such as random access memory (RAM), read only memory (ROM), tapes, magnetic discs, optical discs, volatile memory, non-volatile memory, and any combination thereof.

Further, user equipment 102 includes a communications component 406 that provides for establishing and maintaining communications with one or more parties utilizing hardware, software, and services as described herein. Communications component 406 may carry communications between components on user equipment 102, as well as between user and external devices, such as devices located across a communications network and/or devices serially or locally connected to user equipment 102. For example, communications component 406 may include one or more buses, and may further include transmit chain components and receive chain components associated with a transmitter and receiver, respectively, or a transceiver, operable for interfacing with external devices.

Additionally, user equipment 102 may further include a data store 408, which can be any suitable combination of hardware and/or software, that provides for mass storage of information, databases, and programs employed in connection with aspects described herein. For example, data store 408 may be a data repository for applications not currently being executed by processor 402.

User equipment 102 may additionally include a user interface component 410 operable to receive inputs from a user of user equipment 102, and further operable to generate outputs for presentation to the user. User interface component 410 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

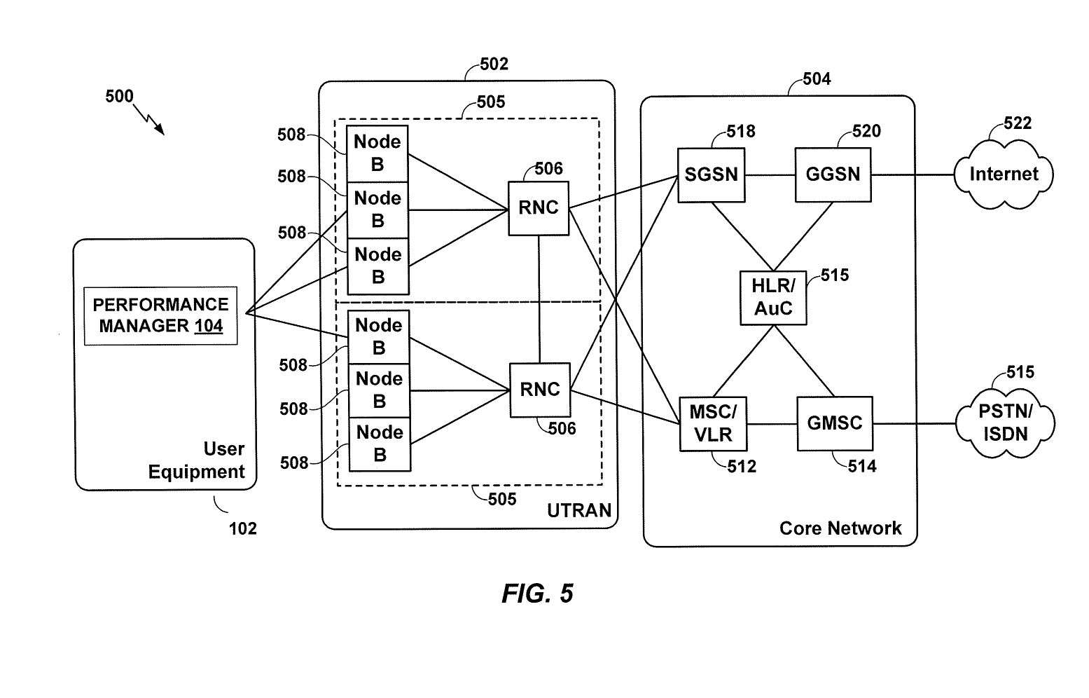

Referring to FIG. 5, by way of example and without limitation, the aspects of the present disclosure are presented with reference to a UMTS system 500 employing a W-CDMA air interface, and may include a UE 102 executing an aspect of performance manager 104 of FIGS. 1 and 3. A UMTS network includes three interacting domains: a Core Network (CN) 504, a UMTS Terrestrial Radio Access Network (UTRAN) 502, and UE 102. In an aspect, as noted, UE 102 (FIG. 1) may be configured to perform functions thereof, for example, including improving performance at a user equipment. Further, UTRAN 502 may comprise network entity 110 and/or base station 112 (FIG. 1), which in this case may be respective ones of the Node Bs 508. In this example, UTRAN 502 provides various wireless services including telephony, video, data, messaging, broadcasts, and/or other services. The UTRAN 502 may include a plurality of Radio Network Subsystems (RNSs) such as a RNS 505, each controlled by a respective Radio Network Controller (RNC) such as an RNC 506. Here, the UTRAN 502 may include any number of RNCs 506 and RNSs 505 in addition to the RNCs 506 and RNSs 505 illustrated herein. The RNC 506 is an apparatus responsible for, among other things, assigning, reconfiguring, and releasing radio resources within the RNS 505. The RNC 506 may be interconnected to other RNCs (not shown) in the UTRAN 502 through various types of interfaces such as a direct physical connection, a virtual network, or the like, using any suitable transport network.

Communication between UE 102 and Node B 508 may be considered as including a physical (PHY) layer and a medium access control (MAC) layer. Further, communication between UE 510 and RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 55.331 v5.1.0, incorporated herein by reference.

The geographic region covered by the RNS 505 may be divided into a number of cells, with a radio transceiver apparatus serving each cell. A radio transceiver apparatus is commonly referred to as a NodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each RNS 505; however, the RNSs 505 may include any number of wireless Node Bs. The Node Bs 508 provide wireless access points to a CN 504 for any number of mobile apparatuses, such as UE 102, and may be network entity 110 and/or base station 112 of FIG. 1. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus in this case is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

For illustrative purposes, one UE 102 is shown in communication with a number of the Node Bs 508. The DL, also called the forward link, refers to the communication link from a NodeB 508 to a UE 102 (e.g., link 114), and the UL, also called the reverse link, refers to the communication link from a UE 102 to a NodeB 508 (e.g., link 116).

The CN 504 interfaces with one or more access networks, such as the UTRAN 502. As shown, the CN 504 is a GSM core network. However, as those skilled in the art will recognize, the various concepts presented throughout this disclosure may be implemented in a RAN, or other suitable access network, to provide UEs with access to types of CNs other than GSM networks.

The CN 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a VLR that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The CN 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 102 through the SGSN 518, which performs primarily the same functions in the packet-based domain as the MSC 512 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a NodeB 508 and a UE 102. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 102 provides feedback to Node B 508 over the HS-DPCCH to indicate whether it correctly decoded a packet on the downlink.

HS-DPCCH further includes feedback signaling from the UE 102 to assist the Node B 508 in taking the right decision in terms of modulation and coding scheme and precoding weight selection, this feedback signaling including the CQI and PCI.

HSPA Evolved or HSPA+ is an evolution of the HSPA standard that includes MIMO and 64-QAM, enabling increased throughput and higher performance. That is, in an aspect of the disclosure, the Node B 508 and/or the UE 102 may have multiple antennas supporting MIMO technology. The use of MIMO technology enables the Node B 508 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 102 to increase the data rate or to multiple UEs 102 to increase the overall system capacity. This is achieved by spatially precoding each data stream and then transmitting each spatially precoded stream through a different transmit antenna on the downlink. The spatially precoded data streams arrive at the UE(s) 102 with different spatial signatures, which enables each of the UE(s) 102 to recover the one or more the data streams destined for that UE 102. On the uplink, each UE 102 may transmit one or more spatially precoded data streams, which enables Node B 508 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

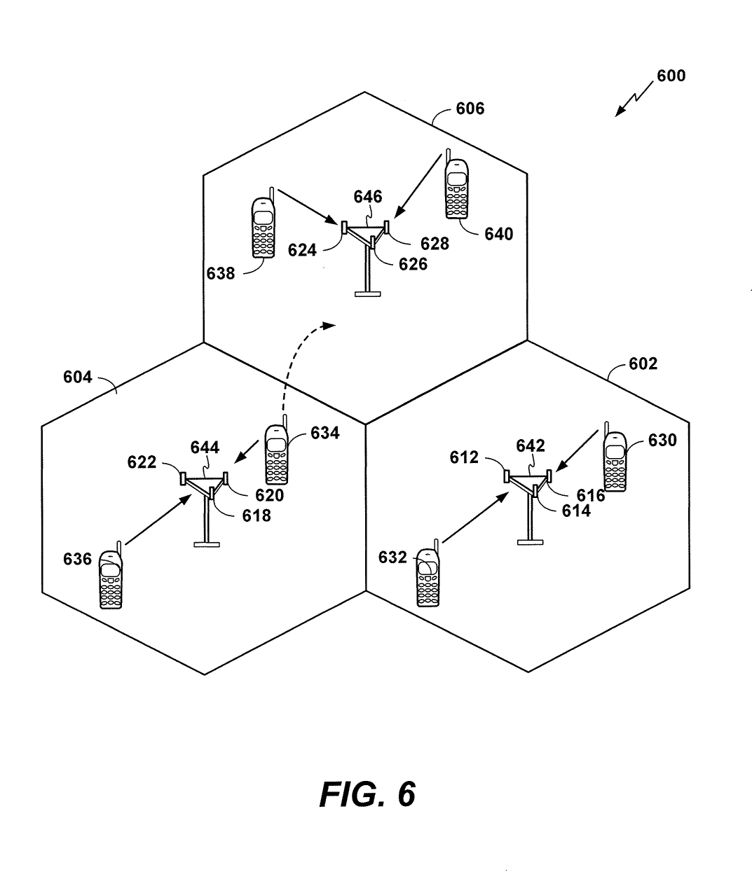

Referring to FIG. 6, an access network 600 in a UTRAN architecture is illustrated, and may include one or more UEs 630, 632, 634, 636, 630, 640, which may be the same as or similar to UE 102 (FIG. 1) in that they are configured to include performance manager 104 (FIG. 1) for improving performance at the user equipment (e.g., UE 102). The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 610, 620, and 622 each correspond to a different sector. In cell 606, antenna groups 624, 626, and 610 each correspond to a different sector. UEs, for example, 630, 632, etc. may include several wireless communication devices, e.g., User Equipment or UEs, including performance manager 104 of FIG. 1, which may be in communication with one or more sectors of each cell 602, 604 or 606. For example, UEs 630 and 632 may be in communication with NodeB 642, UEs 634 and 636 may be in communication with NodeB 644, and UEs 630 and 640 can be in communication with NodeB 646. Here, each NodeB 642, 644, 646 is configured to provide an access point to a CN 504 (FIG. 5) for all the UEs 630, 632, 634, 636, 630, 640 in the respective cells 602, 604, and 606. Additionally, each NodeB 642, 644, 646 may be base station 112 and/or and UEs 630, 632, 634, 636, 636, 640 may be UE 102 of FIG. 1 and may perform the methods outlined herein.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set). In any case, UE 634 may execute reselection manager 64 to perform the reselection operations described herein.

Further, the modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 1002.11 (Wi-Fi), IEEE 1002.16 (WiMAX), IEEE 1002.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

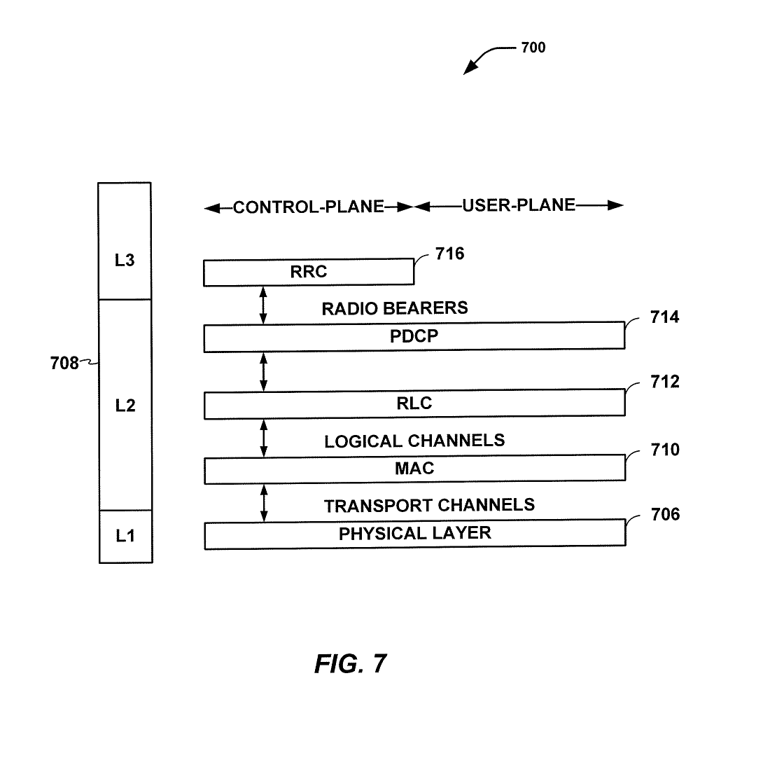

The radio protocol architecture may take on various forms depending on the particular application. An example for an HSPA system will now be presented with reference to FIG. 7. FIG. 7 is a conceptual diagram illustrating an example of the radio protocol architecture for the user and control planes.

Turning to FIG. 7, the radio protocol architecture for the UE, for example, UE 102 of FIG. 1 configured to include performance manager 104 (FIG. 1) for improving performance at the UE is shown with three layers: Layer 1, Layer 2, and Layer 3. Layer 1 is the lowest lower and implements various physical layer signal processing functions. Layer 1 will be referred to herein as the physical layer 706. Layer 2 (L2 layer) 708 is above the physical layer 706 and is responsible for the link between the UE and node B over the physical layer 706.

In the user plane, L2 layer 708 includes a media access control (MAC) sublayer 710, a radio link control (RLC) sublayer 712, and a packet data convergence protocol (PDCP) 714 sublayer, which are terminated at the node B on the network side. Although not shown, the UE may have several upper layers above L2 layer 708 including a network layer (e.g., IP layer) that is terminated at a PDN gateway on the network side, and an application layer that is terminated at the other end of the connection (e.g., far end UE, server, etc.).

The PDCP sublayer 714 provides multiplexing between different radio bearers and logical channels. The PDCP sublayer 714 also provides header compression for upper layer data packets to reduce radio transmission overhead, security by ciphering the data packets, and handover support for UEs between NodeBs. The RLC sublayer 712 provides segmentation and reassembly of upper layer data packets, retransmission of lost data packets, and reordering of data packets to compensate for out-of-order reception due to hybrid automatic repeat request (HARQ). The MAC sublayer 710 provides multiplexing between logical and transport channels. The MAC sublayer 710 is also responsible for allocating the various radio resources (e.g., resource blocks) in one cell among the UEs. The MAC sublayer 710 is also responsible for HARQ operations.

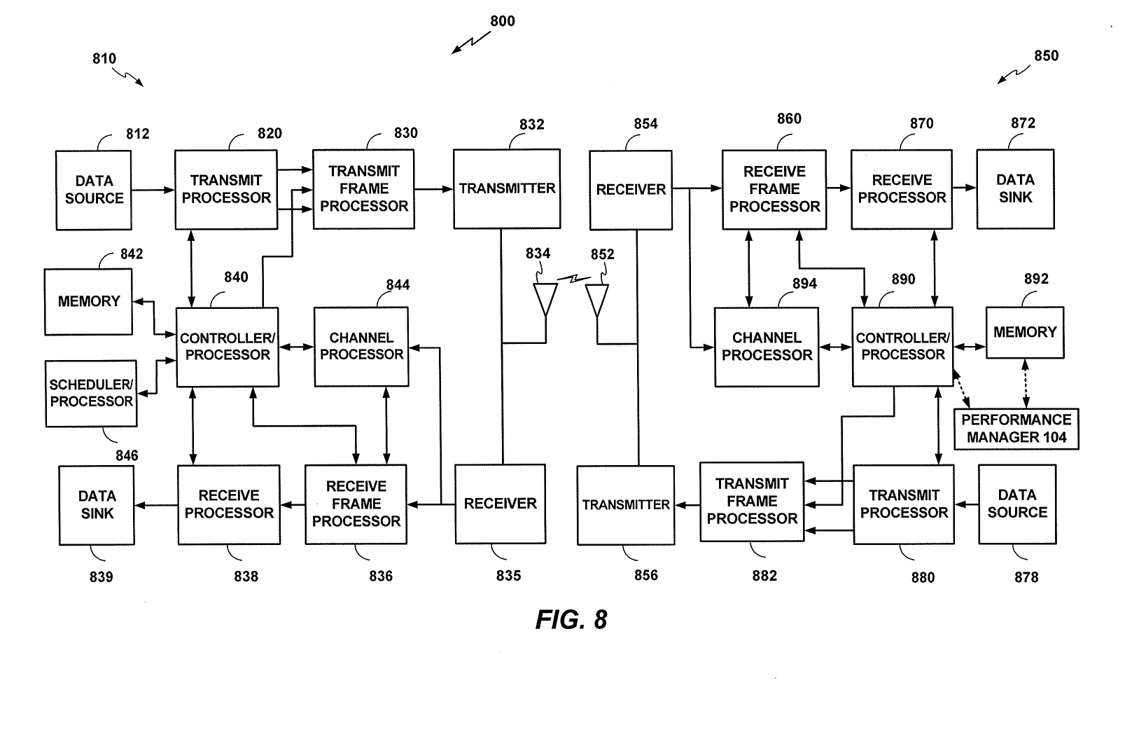

FIG. 8 is a block diagram of a NodeB 810 in communication with a UE 850, where the NodeB 810 may be base station 112 of network entity 110 and/or the UE 850 may be the same as or similar to UE 102 of FIG. 1 in that it is configured to include performance manager 104 (FIG. 1), for improving performance at the UE, in controller/processor 890 and/or memory 892. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 850. The receive processor 850 then performs the inverse of the processing performed by the transmit processor 820 in the NodeB 88. More specifically, the receive processor 850 descrambles and de-spreads the symbols, and then determines the most likely signal constellation points transmitted by the NodeB 88 based on the modulation scheme. These soft decisions may be based on channel estimates computed by the channel processor 894. The soft decisions are then decoded and de-interleaved to recover the data, control, and reference signals. The CRC codes are then checked to determine whether the frames were successfully decoded. The data carried by the successfully decoded frames will then be provided to a data sink 852, which represents applications running in the UE 850 and/or various user interfaces (e.g., display). Control signals carried by successfully decoded frames will be provided to a controller/processor 890. When frames are unsuccessfully decoded by the receiver processor 850, the controller/processor 890 may also use an acknowledgement (ACK) and/or negative acknowledgement (NACK) protocol to support retransmission requests for those frames.

In the uplink, data from a data source 858 and control signals from the controller/processor 890 are provided to a transmit processor 880. The data source 858 may represent applications running in the UE 850 and various user interfaces (e.g., keyboard). Similar to the functionality described in connection with the downlink transmission by the NodeB 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the NodeB 88 or from feedback contained in the midamble transmitted by the NodeB 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the NodeB 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the NodeB 810 and the UE 850, respectively. For example, the controller/processors 840 and 890 may provide various functions including timing, peripheral interfaces, voltage regulation, power management, and other control functions. The computer readable media of memories 842 and 892 may store data and software for the NodeB 810 and the UE 850, respectively. A scheduler/processor 846 at the NodeB 88 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for improving performance at a user equipment (UE), comprising:
calculating an average buffer occupancy value at the UE;
sending a request for resources from the UE to a base station in communication with the UE, wherein request for the resources is based on the average buffer value;
receiving resources from the base station based on the request sent from the UE; and
transmitting data on a uplink (UL), from the UE to the base station, based on one or more of data available for transmission at the UE, or an available transmit power at the UE, or the resources received from the base station.

2. The method of claim 1, wherein calculating the average buffer occupancy value includes:
calculating the average buffer occupancy value based at least over a number of frames or a period of time.

3. The method of claim 1, wherein sending the request includes:
sending the request based on an average buffer occupancy value that is lower than the calculated average buffer occupancy value.

4. The method of claim 1, wherein request for the resources is sent from the UE to the base station via scheduling information (SI).

5. The method of claim 1, wherein transmitting the data on the uplink (UL) includes:
transmitting the data on the UL at a second rate, wherein the second rate is lower than a first rate, where in the first rate is a rate supported by the resources received from the base station.

6. The method of claim 5, wherein transmitting the data on the UL at a second rate includes:
distributing the data over a number of frames, wherein the distributing includes transmitting the data from the UE with the UE at least in a low power amplifier (PA) state, minimizing PA state transitions of the UE from the low PA state to a high PA state, or minimizing PA state transitions of the UE from the high PA state to the low PA state.

7. The method of claim 1, wherein transmitting the data on the uplink (UL), includes:
transitioning power amplifier (PA) states of the UE as a linear function.

8. An apparatus for improving performance at a user equipment (UE), comprising:
means for calculating an average buffer occupancy value at the UE;
means for sending a request for resources from the UE to a base station in communication with the UE, wherein request for the resources is based on the average buffer value;
means for receiving resources from the base station based on the request sent from the UE; and
means for transmitting data on a uplink (UL), from the UE to the base station, based on one or more of data available for transmission at the UE, or an available transmit power at the UE, or the resources received from the base station.

9. The apparatus of claim 8, wherein means for calculating the average buffer occupancy value includes:
means for calculating the average buffer occupancy value based at least over a number of frames or a period of time.

10. The apparatus of claim 8, wherein means for sending the request includes:
means for sending the request based on an average buffer occupancy value that is lower than the calculated average buffer occupancy value.

11. The apparatus of claim 8, wherein request for the resources is sent from the UE to the base station via scheduling information (SI).

12. The apparatus of claim 8, wherein means for transmitting the data on the uplink (UL) includes:
means for transmitting the data on the UL at a second rate, wherein the second rate is lower than a first rate, where in the first rate is a rate supported by the resources received from the base station.

13. The apparatus of claim 12, wherein means for transmitting the data on the UL at a second rate includes:
means for distributing the data over a number of frames, wherein the distributing includes transmitting the data from the UE with the UE at least in a low power amplifier (PA) state, minimizing PA state transitions of the UE from the low PA state to a high PA state, or minimizing PA state transitions of the UE from the high PA state to the low PA state.

14. The apparatus of claim 8, wherein means for transmitting the data on the uplink (UL), includes:
means for transitioning power amplifier (PA) states of the UE as a linear function.

15. A apparatus for improving performance at a user equipment (UE), comprising:
an average buffer occupancy value calculating component to calculate an average buffer occupancy value at the UE;
a resource request sending component to send a request for resources from the UE to a base station in communication with the UE, wherein request for the resources is based on the average buffer value;
a resource receiving component to receive resources from the base station based on the request sent from the UE; and
a data transmitting component to transmit data on a uplink (UL), from the UE to the base station, based on one or more of data available for transmission at the UE, or an available transmit power at the UE, or the resources received from the base station.

16. The apparatus of claim 15, wherein the average buffer occupancy value calculating component is further configured to calculate the average buffer occupancy value based at least over a number of frames or a period of time.

17. The apparatus of claim 15, wherein the resource request sending component sending is further configured to send the request based on an average buffer occupancy value that is lower than the calculated average buffer occupancy value.

18. The apparatus of claim 15, wherein request for the resources is sent from the UE to the base station via scheduling information (SI).

19. The apparatus of claim 15, wherein the data transmitting component is further configured to transmit the data on the UL at a second rate, wherein the second rate is lower than a first rate, where in the first rate is a rate supported by the resources received from the base station.

20. The apparatus of claim 19, wherein the data transmitting component is further configured to distribute the data over a number of frames, wherein the distribution includes transmitting the data from the UE with the UE at least in a low power amplifier (PA) state, minimizing PA state transitions of the UE from the low PA state to a high PA state, or minimizing PA state transitions of the UE from the high PA state to the low PA state.
